(19) United States
(12) Patent Application Publication
(10) Pub. No.: US 2009/0133982 A1
(43) Pub. Date: May 28, 2009

(54) Synchronising Ring For A Synchronising Apparatus, A Friction Lining Blank And Also A Method For The Manufacture Of A Synchronising Ring

(76) Inventors: Ulf Christoffer, Bremen (DE); Marcus Spreckels, Bremen (DE)

Correspondence Address: ROBERT S. GREEN, SULZER METCO (US), INC., 1101 PROSPECT AVENUE, WESTBURY, NY, 11590, US

(21) Appl. No.: 12/195,551

(22) Filed: Aug. 21, 2008

(30) Foreign Application Priority Data
Aug. 23, 2007 (EP) 07114870.4

(51) Int. Cl. F16D 11/04; B23P 15/14

(52) U.S. Cl. 192/66.2; 29/893.37

(57) ABSTRACT

The invention relates to a synchronising ring for a synchronising apparatus of a change speed transmission, including a synchronising ring body with a friction lining, the friction lining being provided in a pre-determinable width between a first axial boundary surface of the friction lining and a second axial boundary surface of the friction lining in the circumferential direction around an axial synchronising ring axis of the synchronising ring on the friction surface, in such a way that the friction lining extends conically at a pre-determinable friction angle α about the synchronising ring axis. In this arrangement a macrogeometric groove is provided in the friction lining for the taking up and/or for the transport of a fluid in such a way that a flow connection is created by the macrogeometric groove for the fluid between the first axial boundary surface and the second axial boundary surface. In accordance with the invention the friction lining is completely removed in the region of the macrogeometric groove. The invention further relates to a friction lining blank for the manufacture of a synchronising ring and to a method for the manufacture of a synchronising ring in accordance with the invention.

### CROSS-REFERENCE TO RELATED APPLICATIONS

The present application claims priority under 35 U.S.C. §119 of European Patent Application No. 07114870.4 filed on Aug. 23, 2007, the disclosure of which is expressly incorporated by reference herein in its entirety.

### STATEMENT REGARDING FEDERALLY SPONSORED RESEARCH OR DEVELOPMENT

Not applicable.

### REFERENCE TO A COMPACT DISK APPENDIX

Not applicable

### BACKGROUND OF THE INVENTION

The invention relates to a synchronising ring, especially to an inner synchronising ring or an outer synchronising ring for a synchronising apparatus of a change speed transmission, to a friction lining blank, and also to a method for the manufacture of such a synchronising ring in accordance with the pre-characterising part of the independent claim in the respective category.

Synchronising rings serve in a mechanical or automatically switchable change speed transmission for example in vehicle transmissions to match the relative speeds between the gear wheel and the transmission shaft arising during a gear change. The synchronisation is attained in this connection by friction between the corresponding friction partners. The functioning of such transmissions and the way the synchronisation process takes place are known per se and do not need to be explained in more detail here to the person averagely skilled in the art.

To protect against premature wear and/or to improve the friction characteristics it is known to provide the friction linings of synchronising rings, which are as a rule made of a metal or a metal alloy, such as brass or steel for example, with a friction layer. In this connection very different types of friction layers are in use, for example thermal spray layers made of molybdenum, carbon friction layers or friction layers made of other materials.

Continually greater demands are also made on the characteristics of the friction surfaces by the continually greater loads which act on the synchronising rings in the operating state.

In this connection in addition to synchronising rings which are treated by means of thermal coating for example, more and more synchronising rings with friction surfaces with an adhesively bonded friction lining consisting for example of a carbon material, are establishing themselves at the moment. Friction linings such as this are manufactured in larger strips or mats made of woven, braided or otherwise processed carbon starting materials, in particular of carbon fibres, which are mostly impregnated with a synthetic resin and thermally and mechanically pre-treated in a manner well known to the person averagely skilled in the art, so that a sufficiently resistant carbon coating material occurs which withstands the enormous demands in the operating state with regard to friction, temperature etc.

The friction linings in the geometry required are then processed from the strips or mats manufactured in this way, for example stamped out or cut out, and are subsequently joined to a mostly metallic synchronising ring body, mainly under high mechanical pressure, using a suitable adhesive.

These methods are well known in the mean time and are described among others, for example in WO 2005/03006.

A well-known problem in association with the design of synchronising rings with which one is generally confronted in the synchronising process, results from the fact that the baulking action in the synchronising process can be reduced by the fact that a film of lubricant forms between the participating friction bodies, from which a hydrodynamic pressure build-up between the friction partners can result which can drastically reduce the friction forces between the friction partners, which has the known negative effect on the synchronising process.

For this reason it is known, for example in synchronising rings which have thermally sprayed on friction surfaces, to introduce axially through-going or end to end grooves through which the lubricant, in other words lubricating oil for example, can flow through in an axial direction between the friction partners, in other words can flow from one side of the synchronising ring along the axial direction to the other side of the synchronising ring, even when the synchronising ring is in close frictional contact with its respective friction partner.

This not only guarantees that the film of lubricant can be forced between the friction partners into the end to end grooves during the synchronising procedure and, since the grooves are end to end, it can also flow on further out of these grooves, so that no back pressure of the lubricant arises between the friction partners.

The grooves simultaneously serve, namely, as storage pockets for lubricant which, as is generally known, also takes over an important function as a coolant in the operating state.

This solution which in itself has proved itself very reliable, could not yet be used with synchronising rings which have adhesively bonded on friction linings, for example a friction lining manufactured from a carbon material.

The main reason for this is to be found in the above-described manufacturing method of synchronising rings such as these. The friction linings are, as explained above, manufactured in the form of geometrically matching strips for a friction surface of a certain type of synchronising ring and then is adhesively bonded to the synchronising body with an adhesive, mostly using strong mechanical pressing, mainly at an elevated temperature.

It is evident that the strips which are to form the friction lining can not be provided with end to end grooves in the full thickness of the friction lining, since the strips would then fall apart into individual friction lining segments, all of which would have to be individually adhered to the synchronising ring in an enormously complex manner, in particular in order to be able to guarantee controlled hydrodynamic conditions, while maintaining the utmost precision, which has presented an insoluble problem technical up until now. Even if it were possible

to carry out a method such as this, it would certainly not be economically viable for mass production.

A first indication of a solution for these problems is known from WO 2005/036006 A1 already mentioned above, the content of which is hereby incorporated as a part of this application.

The solution offered is thus that end to end grooves are provided over the whole width of the friction lining which are, however, not formed in the full thickness of the friction lining, at least in sections. This means that regions in the form of bridges are provided in the grooves, so that the strips which are to be adhesively bonded on a synchronising body as a friction lining, are still connected via the grooves by the bridges, so that the strips do not fall apart into individual friction lining segments in spite of the grooves, but can rather be adhesively bonded cohesively and as a whole to the synchronising ring body in known manner.

It will be understood that this certainly shows an enormous improvement, however, on the one hand, the bridges in the grooves ultimately limit the amount of lubricating oil which can be forced through the grooves at a time, which can be a considerable disadvantage in particular with very quick gear changes. On the other hand, less lubricating oil can naturally be stored in the grooves, which is needed to cool the synchronising ring.

Furthermore, the manufacture of the strips in accordance with WO 2005/036006 A1 is relatively complex, since several different operations are required for the manufacture of grooves and bridges, as a result of which the manufacture can become relatively complicated and thus expensive.

### BRIEF SUMMARY OF THE INVENTION

It is thus the object of the invention to make available an improved synchronising ring with a friction lining and also a method for the manufacture of an improved synchronising ring of this kind, with which a hydrodynamic pressure build-up between the synchronising ring and its frictional partner can be better prevented than in the prior art, wherein at the same time the cooling of the synchronising ring by a fluid, in particular by lubricating oil, is considerably improved and at the same time a very simple and economical manufacture of the synchronising ring is guaranteed.

The subjects of the invention satisfying these objects are characterised by the features of the independent claims 1, 8 and 14.

The respective dependent claims relate to particularly advantageous embodiments of the invention.

The invention thus relates to a synchronising ring for a synchronising apparatus of a change speed transmission, including a synchronising ring body with a frictional lining of the thickness D provided on a friction surface, said friction lining being provided in a pre-determinable width between a first axial boundary surface of the friction lining and a second axial boundary surface of the friction lining in the circumferential direction around an axial synchronising ring axis of the synchronising ring on the friction surface, in such a way that the friction lining extends conically at a pre-determinable friction angle about the synchronising ring axis. In this arrangement a macrogeometric groove is provided in the friction lining for the taking up and/or for the transport of a fluid in such a way that a flow connection is created by the macrogeometric groove for the fluid between the first axial boundary surface and the second axial boundary surface. In accordance with the invention the friction lining is completely removed in the region of the macrogeometric groove.

In this connection, within the scope of this application, the term “macrogeometric groove” is to be understood to mean a groove which is worked into a friction lining in macroscopic dimensions by pressing, stamping out, cutting out or by other measures. The term thus serves for the differentiation of channels on smaller geometrical scales, which are always present to a greater or lesser degree, in particular as surface structures or also as spatial woven structures, primarily in carbon materials. However, they can serve to a far lesser degree as macrogeometric grooves to forward or store a fluid such as lubricating oil.

A synchronising ring in accordance with the invention can thus be designed both as an inner synchronising ring and also as an outer synchronising ring, i.e. an outer peripheral surface and/or an inner peripheral surface can be designed as a friction surface.

In this arrangement the macrogeometric groove preferably extends conically at the friction angle in the direction of the axial synchronising ring axis and, in another special embodiment, the macrogeometric groove can also extend obliquely at an angle of inclination to the synchronising axis.

A storage pocket can be additionally provided in the friction lining for the taking up and/or storage of the fluid, in particular for the increase of the cooling of the synchronising ring by means of a fluid, for example by means of lubricating oil.

Also, as known from the prior art, in addition to the macrogeometric grooves in accordance with the present invention a through flow groove can be provided in one surface of the friction lining between the first axial boundary surface and the second axial boundary surface.

The friction lining as such is particularly preferably constructed from a composite material, especially from a carbon material mixed or reinforced with a resin, in particular from a woven and/or braided and/or otherwise manufactured carbon material.

The synchronising ring body can for example be made from a steel, preferably from C55, C80 or C80M steel, in particular from C35 or C45 steel and/or from a suitable metal alloy, for example of brass and is in this arrangement preferably a chip-forming synchronising ring body shaped from a thin-walled steel band which is formed as a deep-drawn sheet metal part.

The invention further relates to a friction lining blank for the manufacture of an above-described synchronising ring in accordance with the invention, wherein a macrogeometric groove is formed in a friction lining blank of the thickness D and width B in a pre-determinable range, in such a way that a friction lining is removed completely in the region of the macrogeometric groove. In accordance with the invention the friction lining blank is formed by the friction lining with width b and by a continuously connected rim adjacent to the friction lining and having a rim width.

The friction lining blank is particularly preferably formed in such a manner that in the installed state of the synchronising ring provided with the friction lining blank, the macrogeometric groove extends conically at a friction angle in the direction of the synchronising ring axis.

In addition to the macrogeometric groove a storage pocket can especially be provided for the taking up and/or the storage of fluid and/or a through flow groove can be provided between a first axial boundary surface and a second axial boundary surface in a surface of the friction lining, through which the removal or leading away of fluid, for example of lubricating oil, or the storage of lubricating oil can be optimised even further.

In practice, the friction lining blank is preferably constructed from a composite material, especially from a carbon material mixed with a resin or reinforced by a resin, in particular from a woven and/or braided and/or otherwise manufactured carbon material.

Finally the invention further relates to a method for the manufacture of a synchronising ring in accordance with the invention using a friction lining described above. The method in accordance with the invention includes the following steps:

the making available of a synchronising ring body and of the friction lining blank of the thickness D and width B, wherein the friction lining blank is formed by a friction lining including a macrogeometric groove with a width b and by a continuously connected rim with a rim width adjoining the friction lining and

the connection of the friction lining blank to a friction surface of the synchronising ring body and a subsequent removal of the rim of the friction lining blank connected to the synchronising ring body.

In accordance with the invention the rim is removed in such a way, that the friction lining is completely removed on the synchronising ring body in the region of the macrogeometric groove.

The connection of the friction lining blank to the synchronising body takes place preferably in particular by means of an adhesive and/or pressing process, especially by means of a hot isostatic pressing process and/or of a cold isostatic pressing process.

In an embodiment which is important in practical use the macrogeometric groove is stamped out and/or cut out and/or broken out of the friction lining blank, or removed in some other way, before the connection of the friction lining blank to the synchronising body.

The rim is removed by cutting and/or stamping and/or breaking after the connection of the friction lining blank to the synchronising ring body, it can however also be removed using any other suitable method.

In special cases for improving the draining of lubricating oil and/or to increase the storage capacity of lubricating oil in the synchronising ring a storage pocket and/or a through flow groove is stamped out and/or cut out and/or broken out of the friction lining blank before the connection of the friction lining blank to the synchronising body and/or is pressed into the surface of the friction lining blank. Naturally, any other suitable method can also be used, with which storage pockets or through flow grooves can be advantageously worked into the friction lining blank.

### BRIEF DESCRIPTION OF THE DRAWINGS

The invention will be explained in more detail with the help of the schematic drawing which shows:

FIG. 1 is a synchronising ring known from the prior art with a adhesively bonded on friction lining;

FIG. 2 is a known friction lining for a synchronising ring with grooves connected by bridges

FIG. 3 is a friction lining for a synchronising ring in accordance with the invention;

FIG. 4 is a synchronising ring in accordance with the invention with a friction lining blank in the manufacturing stage;

FIG. 5 is an already finished synchronising ring in accordance with the invention;

FIG. 6 is a section in accordance with FIG. 5 along the line I-I;

FIG. 7 is a special embodiment of a friction lining for a synchronising ring in accordance with the invention; and

FIG. 8 is a second special embodiment in accordance with FIG. 7.

### DETAILED DESCRIPTION OF THE INVENTION

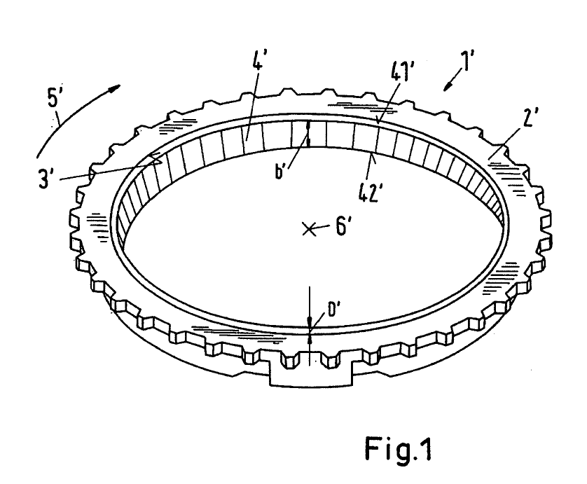

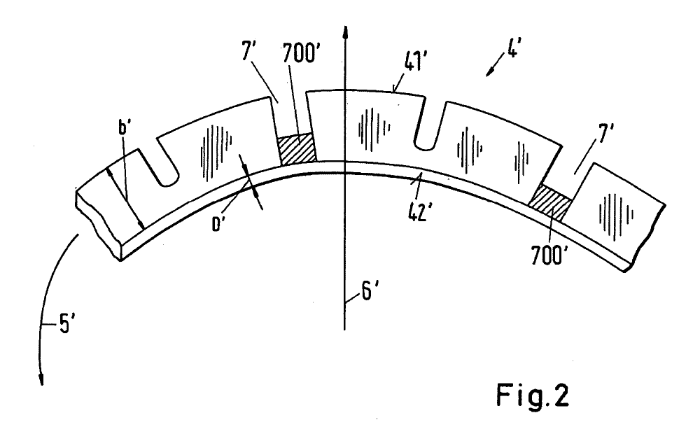

For a better understanding of the invention a synchronising ring known from the prior art with an adhesively bonded on friction lining or a special known friction lining with grooves connected by bridges will be discussed briefly in the following with reference to FIG. 1 and FIG. 2.

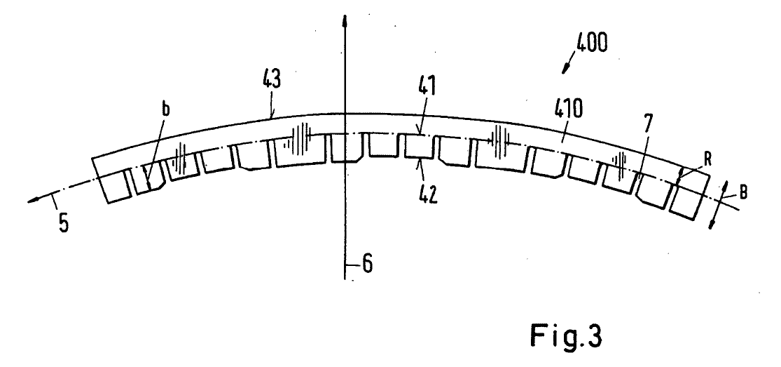

To distinguish the prior art as illustrated in FIG. 1 and FIG. 2, from the pre-sent invention, which will be discussed in special embodiments with reference to FIG. 3 to FIG. 8, the reference numerals in FIG. 1 and FIG. 2, which relate to known features, will be provided with an apostrophe, while reference numerals, which relate to features of the present invention are not provided with an apostrophe.

For a brief explanation of the technical background, a very simple embodiment of a known synchronising ring 1′ is illustrated in FIG. 1. The synchronising ring 1′ of FIG. 1 comprises in a known manner a metallic synchronising ring body 2′ with an inner frictional surface 3′, onto which a friction lining 4′ made of a carbon material reinforced with resin is adhered.

The friction lining 4′ was cut out of a larger mat of the thickness D′ in the width b′ fitting the synchronising ring body 2′ and then adhesively bonded onto the synchronising ring body 2′ at elevated temperature using a suitable adhesive which, for example, was applied on one side of the friction lining 4′ to be adhesively bonded on to the synchronising ring body 2′ at high pressure.

In the installed state the friction lining adhesively bonded onto the synchronising ring body 2′ then extends conically at a pre-determinable friction angle in the peripheral direction 5′ about the synchronising ring axis 6′.

The friction lining 4′ is a very simply structured friction lining 4′ which has no grooves or storage pockets for the lubricating oil, so that the synchronising ring 1′ of FIG. 1 will presumably hardly withstand greater stresses in the operation state.

Compared to this, the friction lining 4′ of FIG. 2, which analogously to FIG. 1 can likewise be adhesively bonded on to a synchronising ring body 2′, signifies a considerable improvement. A friction lining 4′ of this kind has already been proposed earlier for example in WO 2005/036006 A1.

The friction lining 4′ of which a section is shown in FIG. 2 prior to the adhesive bonding to the synchronising body 2′, which is not shown, has macrogeometric grooves 7′, which are provided across the whole width of the friction lining 4′ as end to end grooves, which however are not formed in the full thickness D′ of the friction lining 4′, at least in sections. I.e. regions in the form of bridges 700′ are provided in the grooves 7′, so that the strip of the friction lining 4′, which is to be adhesively bonded onto a synchronising ring body 2′ as a friction lining 4′, is still connected together over the grooves 7′ by means of the bridges 700′, so that the strip does not fall apart into individual friction lining segments, in spite of the grooves 7′, but can be adhesively bonded cohesively and as a whole to the synchronising ring body 2′.

Furthermore more storage pockets 8′ for a fluid, for example for a lubricating oil are provided for the storage of additional lubricating oil, with which not only the cooling of the synchronising ring 1′ can be improved.

The disadvantages of this solution known from the prior art, as regards the hydrodynamic characteristics and the storage and cooling capacity for lubricating oil are self-explanatory to the person averagely skilled in the art and have already been explained in detail in the introduction to the specification.

A friction lining blank 400 for a synchronising ring in accordance with the invention is illustrated in FIG. 3. The friction lining blank in accordance with the invention of FIG. 3 for the manufacture of a synchronising ring 1 has a thickness D and a width B. In a pre-determinable region, between the axial boundary surfaces 41 and 42, which in the ready state of the synchronising ring 1 will form the axial boundary surfaces 41, 42 of the friction lining 4, a plurality of macrogeometric grooves 7 is provided for the conveying or for the storage of lubricating oil. A rim 410, which has a continuous connecting rim of width R, adjoins the axial boundary surface 41. The overall width B of the friction lining blank 400 thus results as the sum of the width b of the later friction lining 4 and the rim width R of the rim 410.

Due to the continuously connecting rim 401, the friction lining blank 400 does not fall apart into individual friction lining segments, which it is impossible to reliably adhesively bond individually to a synchronising body 2 to be coated.

Due to the fact that the friction lining blank 400 is equipped with the rim 410, the friction lining blank 400 can be adhesively bonded as a whole on the synchronising ring body 2 of a synchronising ring 1 without problems, as known in principle from the prior art.

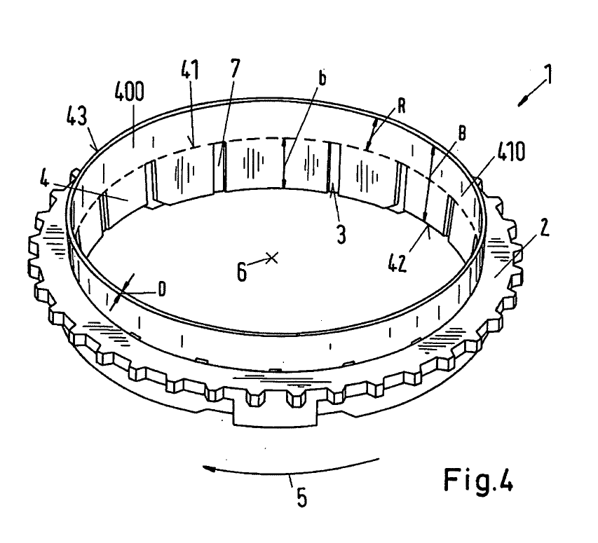

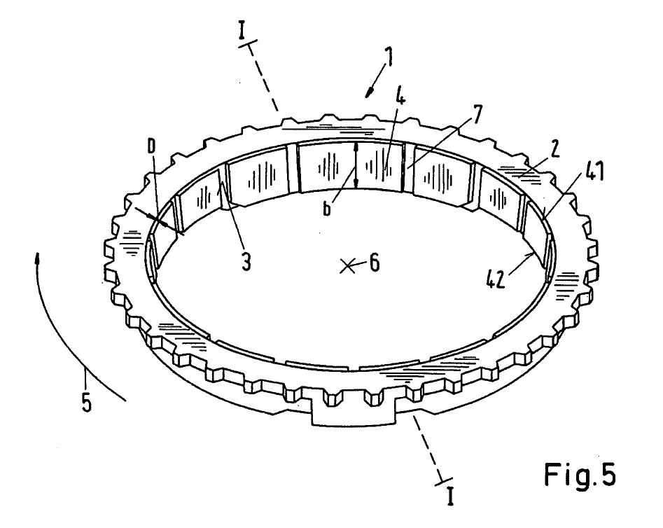

The illustrations of FIG. 4 and FIG. 5, which show a synchronising ring 1 in accordance with the invention with a friction lining blank 40 at the manufacturing stage, are particularly suitable for an explanation of the manufacturing method in accordance with the invention.

The friction lining blank 400 is already adhesively bonded to the synchronizing ring body 2 on a friction surface 3 of the synchronising ring 1. In this arrangement the friction lining blank 400 is adhesively bonded to the friction surface 3 in such a way that the rim 10 is not in adhesive contact across its entire width with the friction surface 3. Moreover, only the region of the friction lining blank 400, which is later to form the friction lining 4 and which contains the macrogeometric grooves 7, is adhesively bonded directly to the friction surface 3.

This means the friction lining blank 400 is only adhesively bonded with the friction surface 3 in the region between the first axial boundary surface 41 and the second axial boundary surface 42, which will axially bound the friction lining 4 later, while the rim 410 of the friction lining blank 400 projects beyond the synchronising ring body 2 in its full width R in the axial direction.

In accordance with the invention, one reaches the finished synchronising ring 1, as it is schematically illustrated in FIG. 5, in that the rim 410 is removed in its full width R after the adhesive bonding to the synchronising body 2, as explained in FIG. 4. This can take place by means of a stamping process, by cutting off the rim 410 along the first axial boundary surface 41, by breaking the rim 410 along the first axial boundary surface 41 or by any other suitable measure, with which the rim 410 can be reliably removed.

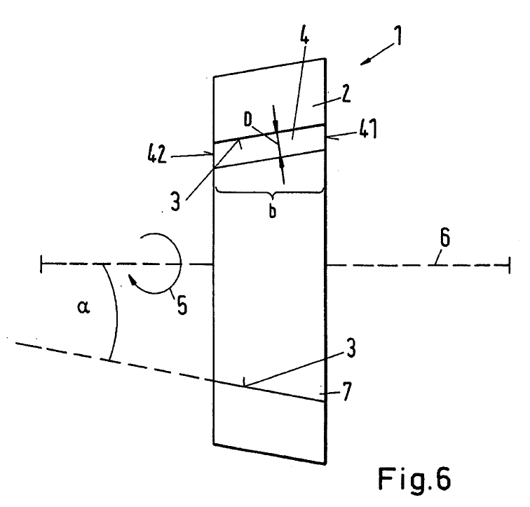

For reasons of clarity a further section along the line I-I in accordance with FIG. 5 is shown in FIG. 6. In this arrangement the section in accordance with FIG. 5 is selected precisely so that in FIG. 6, at the top in the drawing, the section extends through the friction lining 4, which is bounded in the axial direction by the first axial boundary surface 41 and the second axial boundary surface 42, while on the opposite side of the drawing at the bottom the section extends through the macrogeometric groove 7. It is clearly recognisable that the macrogeometric groove of a synchronising ring 1 in accordance with the invention extends across the entire width b of the friction lining 4, without a bridge 700′ being present, as would be mandatory in the case of the known friction linings 4′, which has already been explained in detail in the description of FIG. 2.

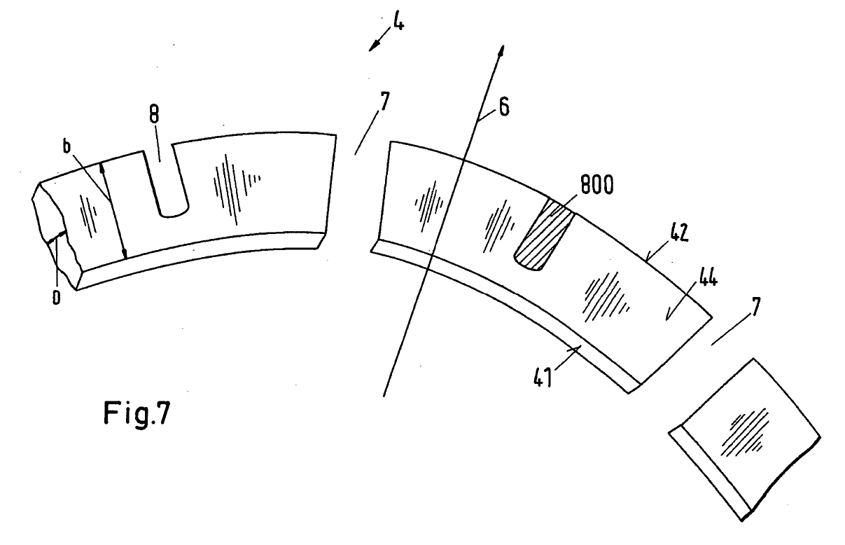

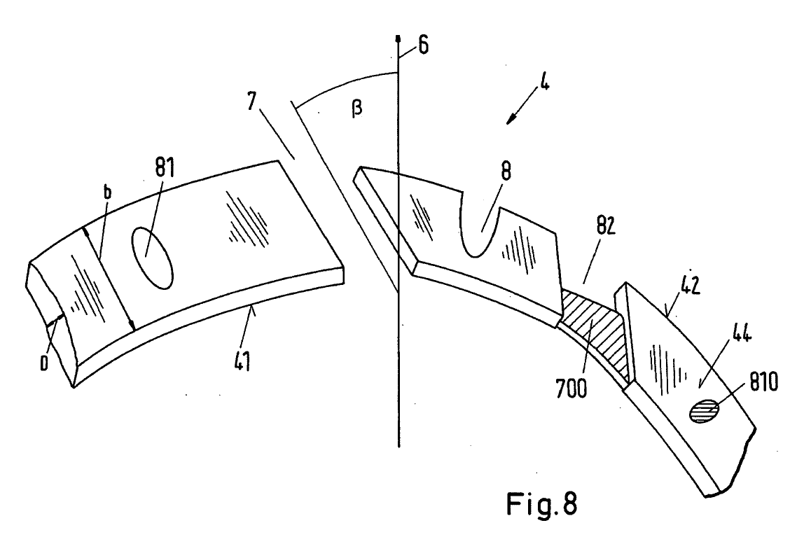

Finally FIG. 7 and FIG. 8 show two special embodiments of friction lining 4 for a synchronising ring 1 in accordance with the invention.

Storage pockets 8, 800, 81, 810 are additionally provided to ensure the storage capacity for lubricating oil in particular, which can serve for a further improved cooling, for example, and which can be designed in quite different ways. Thus, for example, storage pockets 8 can be provided, which can be provided as a recess 8 at a rim of the friction lining 4. Storage pockets 81 in the form of through bores 81 can also be provided. In this connection the storage pockets can, however, also be pressed in in the form of indentations, for example, such as for example the regions 800 and 810 respectively pressed into the surface 44 of the friction lining 4, in which lubricating oil can likewise be stored, which is then available for cooling and no longer for the build up of a hydrodynamic pressure between the friction partners.

FIG. 8 further shows a special possibility of the arrangement of the macrogeometric grooves 7 in the friction lining 4. While the macrogeometric grooves 7 are essentially arranged parallel to the synchronising ring axis 6, the macrogeometric grooves 7 of FIG. 8 are aligned diagonally at an angle of inclination β to the synchronising ring axis 6.

Through flow grooves 82 with bridges 700 can, naturally, also be additionally provided, as shown in FIG. 8 by way of example, and as they are known per se from WO 2005/036006 A1.

It will be understood that the macrogeometric grooves 7 can also have a curved shape for example, or can be designed in any other suitable form.

It will further be understood that all the embodiments explicitly discussed in this application are only to be understood as examples for the invention and in particular all suitable combinations which can be advantageously employed for special uses, and all further developments obvious to the person averagely skilled in the art, are covered by the invention.

1. A synchronising ring for a synchronising apparatus of a change speed transmission, including a synchronising ring body with a friction lining of the thickness provided on a friction surface, said friction lining being provided in a pre-determinable width between a first axial boundary surface of the friction lining and a second axial boundary surface of the friction lining in the circumferential direction around an axial synchronising ring axis of the synchronising ring on the friction surface, in such a way that the friction lining extends conically at a pre-determinable friction angle (α) about the synchronising ring axis, wherein a macrogeometric groove is provided in the friction lining for the taking up and/or for the transport of a fluid in such a way that a flow connection is created by the macrogeometric groove for the fluid between the first axial boundary surface and the second axial boundary surface, characterised in that the friction lining is completely removed in the region of the macrogeometric groove.

2. A synchronising ring in accordance with claim 1, wherein the macrogeometric groove extends conically at the friction angle (α) in the direction of the axial synchronising ring axis.

3. A synchronising ring in accordance with claim 1, wherein the macrogeometric groove extends obliquely at an angle of inclination (β) to the synchronising ring axis.

4. A synchronising ring in accordance with claim 1, wherein a supply pocket is provided for at least one of taking up and storage of the fluid.

5. A synchronising ring in accordance with claim 1, wherein a through flow groove is provided between the first axial boundary surface and the second axial boundary surface in a surface of the friction lining.

6. A synchronising ring in accordance with claim 1, wherein the friction lining is constructed from a composite material.

7. A synchronising ring in accordance with claim 1, wherein the synchronising ring body is made from a steel.

8. A friction lining blank for the manufacture of a synchronising ring in accordance with claim 1, wherein a macrogeometric groove is formed in the friction lining blank of the thickness (D) and width (B) in such a way that a friction lining is completely removed in the region of the macrogeometric groove characterised in that the friction layer blank is formed by the friction lining with a width (b) and a continuously connecting rim with a rim width (R) adjoining the friction lining.

9. A friction lining blank in accordance with claim 8, wherein the friction lining blank is formed in such a way that in the installed state of the synchronising ring provided with the friction lining blank, the macrogeometric groove extends conically at a friction angle (α) in the direction of the axial synchronising ring axis.

10. A friction lining blank in accordance with claim 8, wherein the friction lining blank is formed such that in the installed state of the synchronising ring provided with the friction lining blank, the macrogeometric groove extends diagonally at an angle of inclination (β) towards the axial synchronising ring axis.

11. A friction lining blank in accordance with claim 8, wherein a storage pocket is provided for at least one of the taking up and storage of a fluid.

12. A friction lining blank in accordance with claim 8, wherein a through flow groove is provided between a first axial boundary surface and a second axial boundary surface in a surface of the friction lining.

13. A friction lining blank in accordance with claim 8, wherein the friction lining blank is constructed from a composite material.

14. A method for the manufacture of a synchronising ring (1) in accordance with claim 1, the method including the following steps:
1. the provision of a synchronising ring body and of the friction lining blank of the thickness (D) and width (B) wherein the friction lining blank is formed by a friction lining including a macrogeometric groove and having a width (b) and a continuously connecting rim with a rim width (R) adjoining the friction lining,
2. the connection of the friction lining blank to a friction surface of the synchronising ring body; and
3. the removal of the rim from the friction lining blank connected to the synchronising ring body,
4. wherein the rim is removed in such a way that the friction layer is completely removed on the synchronising ring body in the region of the macrogeometric groove.

15. The method in accordance with claim 14, wherein the connection of the friction lining blank to the synchronising body is established in particular by means of at least one of an adhesive process, a pressing process, a hot isostatic Dressing process and a cold isostatic pressing process.

16. A method in accordance with claim 14, wherein the macrogeometric groove is at least one of stamped outs cut out, and broken out of the friction lining blank before the connection of the friction lining blank to the synchronising body.

17. A method in accordance with claim 14, wherein the rim is removed by at least one of cutting, stamping, and breaking after the connection of the friction lining blank to the synchronising ring body.

18. A method in accordance with claim 14, wherein at least one of a storage pocket and a through flow groove is at least one of stamped out, cut out and broken out of the friction lining blank at least one of before the connection of the friction lining blank to the synchronising body and is pressed into the surface of the friction lining blank.

19. The synchronising ring of claim 6, wherein the composite material is a carbon material mixed with a resin.

20. The synchronising ring of claim 6, wherein the composite material is a carbon material which is at least one of woven and braided.

21. The synchronising ring in accordance with claim 1, wherein the synchronising ring body is made from at least one of C35 steel, C45 steel, C55 steel, C80 steel and C80M steel.

22. The friction lining blank of claim 13, wherein the composite material is a carbon material mixed with a resin.

23. The friction lining blank of claim 13, wherein the composite material is a carbon material which is at least one of woven and braided.
